(19) United States
(12) Patent Application Publication
(10) Pub. No.: US 2007/0058518 A1
(43) Pub. Date: Mar. 15, 2007

(54) Imformation recording medium and method for manufacturing the same

(76) Inventors: Akemi Hirotsune, Saitama (JP); Motoyasu Terao, Hinode (JP); Takeshi Maeda, Koganei (JP); Masaki Mukoh, Tokyo (JP); Toshimichi Shintani, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/501,048

(22) Filed: Aug. 9, 2006

(30) Foreign Application Priority Data
Sep. 12, 2005 (JP) 2005-263510
Jun. 1, 2006 (JP) 2006-153535

(51) Int. Cl. G11B 7/24

(52) U.S. Cl. 369/275.3

(57) ABSTRACT

In an optical disk in which a recording layer is selected by applying voltages, a different address pit is formed in each recording layer. To this end, a plurality of recording layers are formed in a way that the plurality of recording layers follow a concavo-convex shape formed in a substrate, and thus the plurality of recording layers keep the concavo-convex shape even after the formation; mutually different address marks are add-on written, as a part of the address information, respectively to recording layer so that the address and track information can be confirmed in each layer.

### CLAIM OF PRIORITY

The present application claims priority from Japanese applications JP2005-263510 filed on Sep. 12, 2005 and JP 2006-153535 filed on Jun. 1, 2006, the contents of which are hereby incorporated by reference into this application.

### BACKGROUND OF THE INVENTION

1. Field of the Invention

The present invention relates to an information recording medium for recording/reproducing information using light, and a method for manufacturing the same.

2. Description of the Related Art

The major characteristics of an optical disk are that a recording medium (disk) can be dismounted from a recording/reproducing apparatus, and that the recording medium is inexpensive. In the optical disk device, therefore, it is desirable that higher speed and higher density be achieved without losing these characteristics. It is preferable that multilayer, which takes advantage of the characteristics of long range nature and transmissivity of light, be made in order to increase the effective recording density (effective surface density) in an optical disk. However, one of reproduced signal quality and the recording sensitivity has to be sacrificed because the transmittance of each layer and the recording sensitivity are in a trade-off relationship with each other in a case of three or more layers.

In this event, techniques for resolving this trade-off have been developed. For example, in Example 2 of Japanese laid-open Official Gazette No. 2003-346378 by the inventors of the present intention, there is described that: a recording layer made by using an electro-chromic material is formed as multilayer; a voltage is applied to a pair of electrodes which sandwich a desired recording layer; the absorption spectrum of the recording layer itself is selectively changed to be colored; and information is recorded in the layer, a color of which has been changed. Moreover, there is also known a multilayer optical disk including a switching layer shown in Fung-Hsu Wu, Tom D. Milster, and Han-Ping D. Shieh, Write-Once Multilayer Optical Disk using Transparent Recordable Material with an Optical Switching Layer, Technical Digest of International Symposium on Optical Memory (ISOM) 2003, Fr-J-06 (2003) p. 274. This switching layer is a layer of material having a nonlinear property in which the optical absorption and reflection increase rapidly as the intensity of irradiating light increases. If the focus position is determined to be a predetermined layer, the optical absorption of this layer increases rapidly to generate heat due to the switching layer, thereby allowing user data to be recorded and reproduced.

### SUMMARY OF THE INVENTION

As techniques for achieving multilayer, there are a conventional method and new methods, such as a method described in Japanese laid-open Official Gazette No. 2003-346378, and a method described in Technical Digest of International Symposium on Optical Memory (ISOM) 2003, Fr-J-06 (2003) p. 274. In the conventional method, a recording layer made of oxide, sulfide, or organic material with high transmissivity is formed to be multilayered, the focal position of a laser beam is focused on a layer to be recorded, and thereby the refractive index and the extinction coefficient thereof are changed by heating, and the like. In the new methods, a recording layer, which is made of an electro-chromic material layer and a solid electrolyte layer, and which is sandwiched by transparent electrodes, is repeatedly formed to be multilayered. Thereafter, a selected recording layer is made transparent, and is colored by applying a voltage thereto, thereby recording and reproducing is made possible only in the colored layer. In the conventional method, because a recording mark for each layer is always visible, layers except for a layer, from which a signal is read, need to be defocused so as not to cause a cross talk. For this reason, a layer spacing interval needs to be 20 μm or more.

As shown in FIG. 1, among the latter new methods, especially in a multilayer optical disk, in which layers are selected by use of a voltage, not only the recording mark but also the other portions are transparent, and a signal is not visible in the non-selected layers. The layer spacing interval, therefore, does not need to be widened as in the multilayer optical disk of the conventional method. Accordingly, the advantages are that even in a multilayer disk, problems, such as warping and cracking due to a fact that the total film thickness is large, are unlikely to occur, and that layers may be formed without the need for forming a replica layer of grooves and pits. Moreover, a problem that light attenuates due to optical absorption in layers towards the side of light incidence is also resolved. On the other hand, however, there is a problem in that, because the layer spacing interval is narrow, focus error signals overlap with one another, and that which layer is currently focused is not known. Moreover, as another problem, it has been found out that, as recording layers are formed in multilayer, recording layers formed earlier on a lower side are in the shape along a concavo-convex shape of a substrate while recording layers formed later on an upper side do not maintain the concavo-convex shape of the substrate. Instead, the width of the concaved portion of the layers formed later is gradually narrowed to the point of being flat. Thus, when attempting to track the groove for tracking, which is located in the recording layer of the upper side, as in a case of the ordinary optical disk, a tracking error is likely to occur even if a predetermined layer is auto-focused. In a case where a two-beam head is used, there is also a method, in which: recording/reproducing layers are planarized; a servo beam is focused on a position where a reproduced pit signal of a reflective layer (servo layer) in the substrate surface is the maximum; and the focal position of another beam is shifted by a positional difference between the servo layer and the predetermined recording layer. However, there is a problem that a coating step is included in order to planarize the recording/reproducing layers.

As a method of addressing the problem that the width of the concaved portion of the layers formed later is narrowed, there is a method for carrying out bias-sputtering at the time of forming a film. With this method, after the concavo-convex portion is slightly distorted due to the formation of the film, the concavo-convex shape is maintained without being changed, though is not completely the same concavo-convex shape as that of the substrate surface even when the total film thickness is made large after multiple layers are formed. Accordingly, a groove-wobbling pattern and a pit pattern of each layer are made similar to the corresponding patterns in the substrate surface. In this case, although the concavo-convex portion for describing an address can be read, the layer having the above concave-convex portion cannot be confirmed because each later has the concavo-convex portion identical to one another. In this case, a two-beam head is used. One beam thereof is focused on a reflective layer (servo layer) immediately above the substrate in which the grooves and pits are formed. The focal position of the other beam, in which the focal-positional relationship with the former beam is substantially fixed, is caused to be on a layer for recording and reproducing. Thereby, the confirming and correcting of the groove position allows for more precise spot positioning than in the case where the bias-sputtering is not carried out. However, this two-beam head is a cause for a size of the optical head to be larger. The positional relationship between the two beams may also move due to temperature variations and the like.

It is an object of the present invention to resolve these problems and concerns, and to provide an information recording medium capable of achieving stable, large capacity, high speed recording while keeping high compatibility with the conventional optical disk and the possibility of miniaturization of the device.

An information recording medium of the present invention includes a substrate in which a pit pattern or a groove-wobbling pattern is formed, and a plurality of recording layers formed on the substrate. The plurality of recording layers include address information which differs for each recording layer. The address information in each layer is described using at least a part of the pit pattern or the groove-wobbling pattern similar to the pit pattern or the groove-wobbling pattern of the substrate. Specifically, the address information is described using the following: at least the part of the pit pattern or the groove-wobbling pattern, which are similar to the pit pattern or the groove-wobbling pattern of the substrate, and which is formed in a position overlapping with the pit pattern or the groove-wobbling pattern of the substrate; and a mark which is add-on written to the above part of the pit pattern or the groove-wobbling pattern. The mark may be a mark described by a difference in refractive indexes.

Each recording layer may have different address information by erasing the part of the pit pattern or the groove-wobbling pattern, which is similar to the pit pattern or the groove-wobbling pattern of the substrate, and which is formed in a position overlapping with the pit pattern or the groove-wobbling pattern of the substrate. The erasing of the pit pattern or the groove-wobbling pattern is made possible by forming an add-on written mark, whose the sum of a phase between the reverse phase and the phase difference in pit is 2π in a round trip of light, or by partially filling a concaved portion to planarize corresponding one of the pit pattern and the groove-wobbling pattern.

A method of manufacturing an information recording medium according to the present invention includes the steps of forming a plurality of recording layers on a substrate in which the pit pattern or the groove-wobbling pattern is formed so that the pit pattern or the wobble pattern is stored in a recording layer; and forming address information, which differs for each recording layer, by erasing the part of the pit pattern or the groove-wobbling pattern, which each recording layer has, and/or by add-on writing a mark to the pit pattern or the groove-wobbling pattern.

In the information recording medium of the present invention, even in a form of multilayer, the address of each layer can be reliably confirmed, compatibility with the conventional disk is high, and high speed, large capacity recording and reproducing is made possible.

### BRIEF DESCRIPTION OF THE DRAWINGS

FIG. 1 is a principle view which shows that there is no cross talk between layers of a multilayer disk recording/reproducing apparatus of an example of the present invention.

FIG. 2 is a view showing a structure in cross section taken along a line in the recording track direction (circumferential direction) of a part of a multilayer disk recording medium of an example of the present invention.

FIG. 3 is a view showing a structure in cross section taken along a line in the direction perpendicular to the recording track of a part of the multilayer disk recording medium of the example of the present invention.

FIG. 4 is a schematic cross-sectional view of the multilayer disk of the present invention after being bonded.

FIG. 5 is a view showing an example of arrangement of concavo-convex pits and add-on written phase marks in a substrate surface.

FIG. 6 is a cross sectional view showing a structure of a recording-reproducing apparatus of an example of the present invention.

FIG. 7 is a block diagram showing a configuration of the recording-reproducing apparatus of an example of the present invention.

FIG. 8 is a schematic view of a format of DVD-RAM.

FIG. 9 is a view showing a format of a sector.

FIG. 10 is a view showing a data arrangement of a header portion.

FIG. 11 is a view showing an example of application to a sampled-servo method using a pit pair which is intermittently arranged on a track.

FIG. 12 is a view showing an example in which the present invention is applied to wobbles in a groove.

FIG. 13 is a view showing a structure in cross section taken along a line in the recording track direction (circumferential direction) of a part of the multilayer disk recording medium of an example of the present invention.

FIGS. 14A and 14B are views explaining a method of recording an add-on mark of the present invention.

FIGS. 15A to 15C are views explaining signal detection in a case where the length of signal obtained from add-on marks differs.

FIGS. 16A to 16C are views explaining the signal detection in a case where the level of signal obtained from add-on marks differs.

FIGS. 17A and 17B are views showing an example of arrangement of an add-on mark of the present invention.

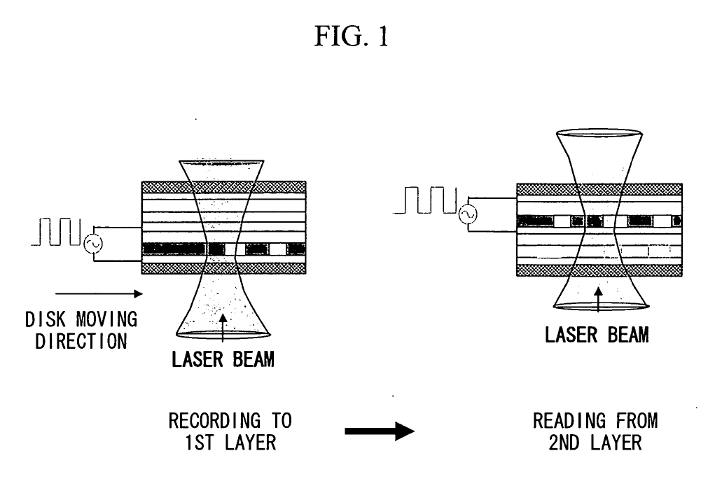

### DESCRIPTION OF THE PREFERRED EMBODIMENTS

In the present invention, a substrate with the shape similar to that of an optical-disk substrate, such as DVD-RAM, is used as a recording medium. This recording medium has a substrate with a repeated concavo-convex shape or an ultraviolet curing resin layer with a repeated concavo-convex shape in a substrate surface. As to the surface shape of a cross section of this concavo-convex portion taken along a line in the radial direction of the disk in a plane perpendicular to the substrate surface, a level difference portion thereof has a slope, and a set of a substantially trapezoid (without a longer base) and an substantially inverted trapezoid (without a longer base) is repeated therein. Moreover, when the position of a layer departs from the substrate surface or from the ultraviolet curing resin layer due to the multilayered formation, repetition of arc shapes or repetition of a set of a substantially triangle without a base and a substantially inverted triangle without a base is observed. When a DC-bias voltage is applied somewhat strongly at the time of forming a film, Ar ions strike strongly and partially etch the film surface, providing a set of a shape close to a triangle without a base and a shape close to an inverted triangle without a base. After forming the layers to some extent using this method, the formation is made while the concavo-convex shape is substantially unchanged. Accordingly, the groove-wobbling pattern and the pit pattern of each layer are made similar to the corresponding patterns in the substrate surface. If a DC bias is applied somewhat weakly, the top of the concavo-convex portion is not sharpened, and a shape close to a part of an arc is repeated.

In a case where such a multilayer-formed disk is formed, an issue arises as to how the next address mark is when attempting to focus-track with a one beam head. The present invention has the following characteristics with regard to this point.

(1) Each of a plurality of recording layers has a mutually different pit or groove-wobbling pattern.

(2) A recording mark is formed in a part of each of the recording layers.

(3) At least a part of a pit or a groove-wobbling pattern of the recording layer away from the substrate is add-on written.

(4) The above-described add-on writing is carried out by causing, in a part of the formed film of a multilayer disk, two-photon absorption or optical absorption of a wavelength different from that of the recording and reproducing to thereby change the refractive index of the part of the formed film of the multilayer disk.

(5) A part of the pit pattern of the substrate is erased in the pit or the groove-wobbling pattern of the recording layer away from the substrate.

(6) The above-described partial erasing of the pit or the groove-wobbling pattern is carried out by forming an add-on written mark, whose the sum of a phase between the reverse phase and the phase difference in pit is 2π in a round trip of light, or by partially filling a concaved portion with an ink jet or the like to planarize corresponding one of the pit and the groove-wobbling pattern.

(7) The pit pattern may include pits used for a sampled-servo method.

Recording is carried out by causing a portion irradiated with a pulse laser beam of high power not to be colored, or to color slowly even when a coloring voltage is applied thereto. It is an advantage that an optical system of the conventional optical disk can be used as the optical system for this method. Hereinafter, specific descriptions will be given with reference to the accompanying drawings.

### EXAMPLE 1

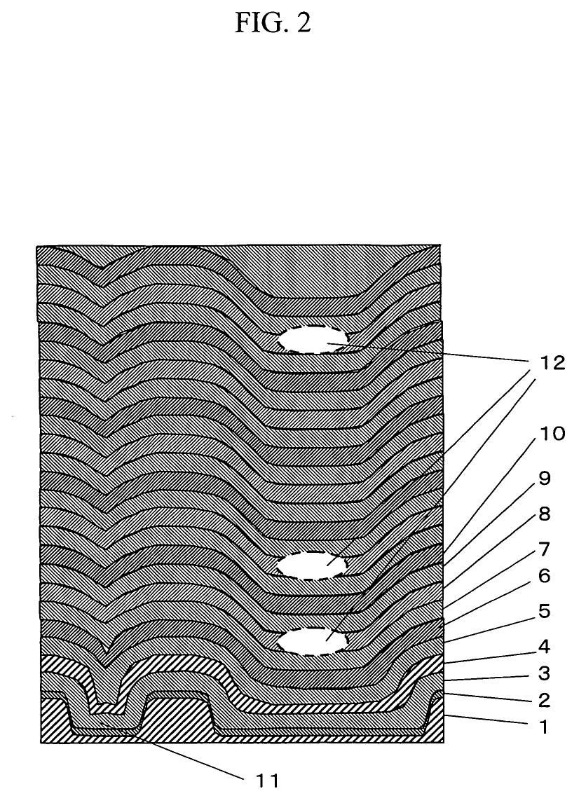

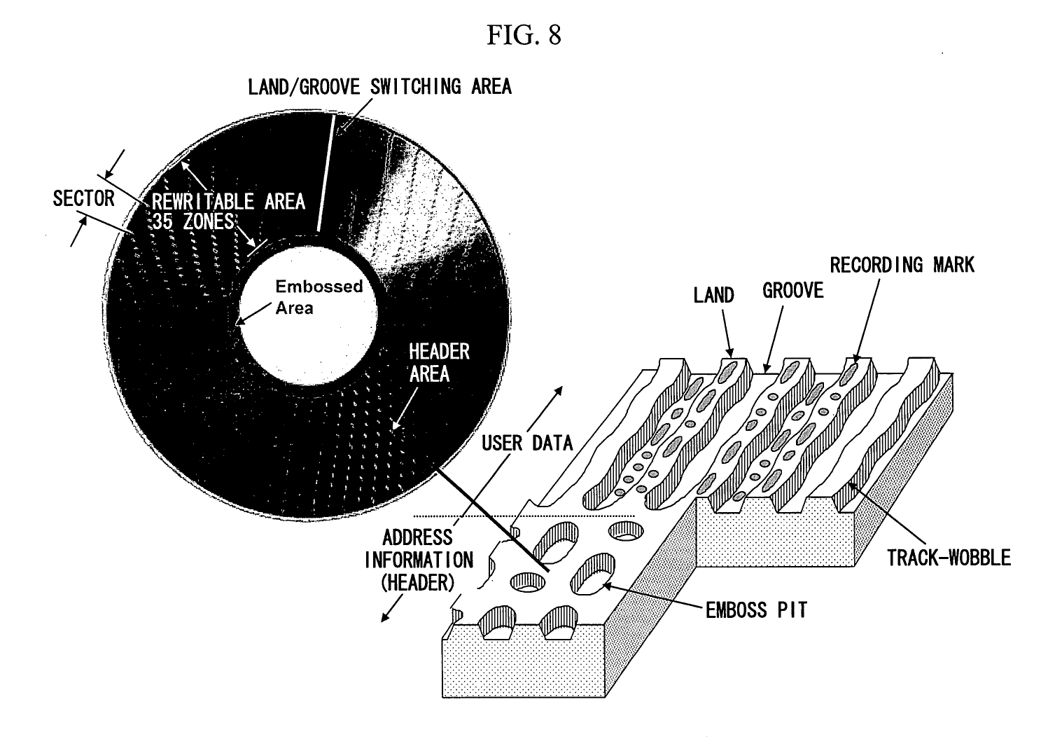

FIG. 2 is a cross-sectional view showing a structure taken along a line in the recording track direction (circumferential direction) of a part of a multilayer disk recording medium of an example of the present invention. As a part of an address pit portion shown in FIG. 2, each layer is formed on a substrate 1 having pits for describing an address and a clock signal-SYNC signal, and grooves used for tracking. The format of this substrate is the same as the format of DVD-RAM. A schematic view of the format of DVD-RAM is shown in FIG. 8. Each recording layer has a three layer structure in which another layer is added on top of an electro-chromic material layer and a solid electrolyte layer. In a case of the three-layer structure, the three layers are, for example, a WO₃ layer of 100 nm which is a reduction coloring type first coloring layer, a Ta₂O₅ layer of 100 nm which is a solid electrolyte layer, and a layer of 30 nm of IrOₓ or NiOₓ (x is a positive number of less than one) which is an oxidation coloring type second coloring layer. Alternatively, the layer of 30 nm is made by adding another metal or a semi-metal element to the above IrOₓ and NiOₓ.

Namely, as shown in FIG. 2, the following layers are formed on top of a polycarbonate substrate 1. The layers are: an Ag₉₄Pd₄Cu₂ semitransparent reflective layer 2 with the film thickness of 20 nm; dummy layers 3, 4, and 5 of SiO₂, GeO₂, and SiO₂, which have the thickness of 100 nm in total; an ITO transparent electrode 6 with the film thickness of 100 nm; a reduction type electro-chromic material layer (WO₃) 7 with the film thickness of 100 nm; a solid electrolyte layer (Ta₂O₅) 8 with the film thickness of 100 nm; an oxidized type electro-chromic material layer (Ir—Sn—O) 9 with the film thickness of 30 nm; and an ITO transparent electrode 10 with the film thickness of 100 nm. Thereafter, by repeating the same sequence, five recording layers, each of which is sandwiched by the ITO transparent electrode from both sides of the layer, are formed in order of the reduction type electro-chromic material layer, the solid electrolyte layer, the oxidized type solid electrolyte layer, the ITO transparent electrode, the reduction type electro-chromic material layer, the solid electrolyte layer, the oxidized type electro-chromic material layer, and the ITO transparent electrode. A metal semitransparent reflective layer may be omitted.

The solid electrolyte layer is defined as a layer in which plus ions, such as hydrogen, lithium, sodium, and magnesium can be stably kept inside to be moved. The solid electrolyte layer of Ta₂O₅ is fabricated so as to contain moisture thereinside. The WO₃ layer and Ir—Sn—O layer are formed by reactive sputtering using an Ar—O₂ gas. In case of Ir—Sn—O, an Ir—Sn target is used. As other electro-chromic material of inorganic, procian blue (KₓFe^{II}_{y}Fe^{III}_{z}(CN)₆) which is an iron cyanide, MoO₃, Nb₂O₅, V₂O₅, TiO₂, NiOOH, CoOOH, Rh₂O₃, IrOₓ (x is a positive number of less than one), ZrNCl, InN, SnNₓ (x is a positive number of less than one), MnOₓ (x is a positive number of less than two), a compound (mixed) thin film WO₃—MoO₃, or the like can be used. WO₃—MoO₃ has the advantage that the optical absorption near a wavelength of 400 nm can be increased.

A DC bias supplied from outside at the time of sputtering is set at −100V. Accordingly, when an AC voltage component is negative at side of the substrate, the substrate is etched by sputtering with argon ions. If the number of the formed layers is small, the bias sputtering is carried out only to the dummy layer, and ordinary sputtering may be carried out to the electro-chromic material layer, the transparent electrode, and the like.

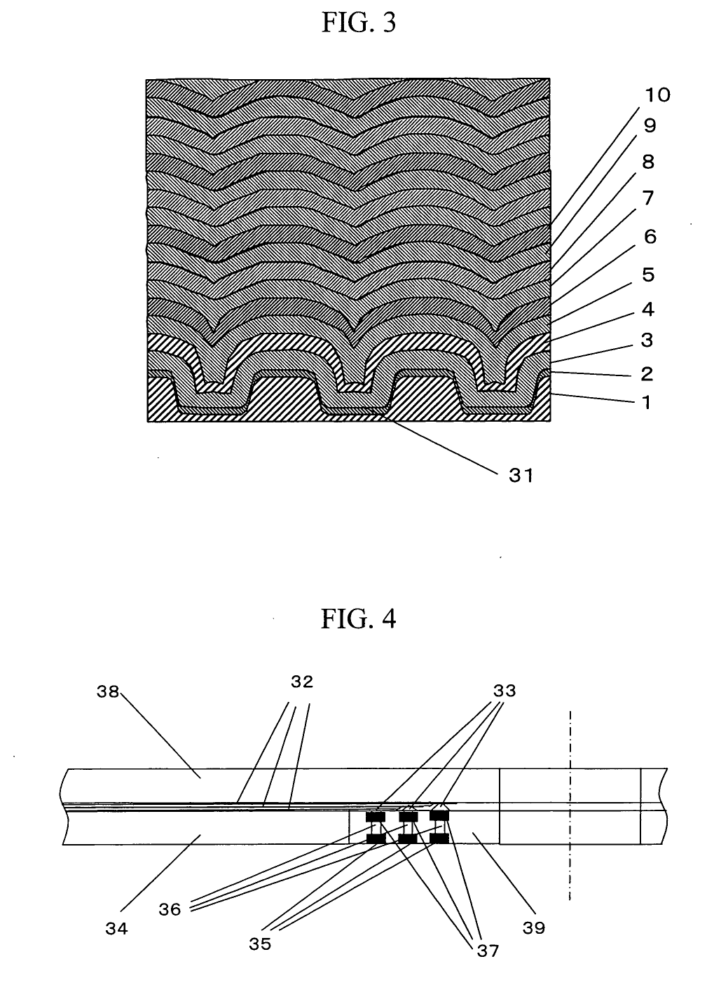

In case of formation by sputtering described above, a film sticks also to a level difference portion of the groove and the pit due to the material atoms or molecules which enters the substrate diagonally. Thus, if a large number of layers are formed by the ordinary method, the width of the groove or pit is narrowed sequentially, the width of a land between the respective grooves is wider sequentially. It is therefore difficult to read the tracking and address signals, a clock signal, and the like. This can be avoided by applying a method used for forming a photonic crystal. This is the method described in 15 p-T-11, p. 1025, Proceedings Vol. 3, 59th Japan Society of Applied Physics, 1998, and sputtering is carried out by applying a DC-bias voltage so that a film formed on the substrate can be readily subjected to sputtering by argon ions. A film is thereby formed while partially being etched by sputtering, and the film thickness distribution is made different from the ordinary one. The photonic crystal in the above-described Proceedings is two-dimensional periodic concavo-convex, and that of this example is one-dimensional periodic concavo-convex in the shape of groove and in the shape of pit. However, although there are some differences in the effect of DC-bias conditions, formation of multiple layers is made possible so that a shape in cross section is substantially similar to the one described in the Proceedings. If sputtering is carried out under such conditions, the groove deforms into a roof shape as the formation proceeds, as shown in FIG. 3. However, the ratio of a concaved portion to a convex portion is unchanged, and thereby tracking and reading of addresses and the like can be carried out without problems. That is, the groove-wobbling pattern and the pit pattern of each layer are similar to the corresponding patterns in the substrate surface. In this event, the bias voltage in the range of −50V to −500V is preferable. A cross section, in the radial direction, of the user data storage area of a disk is as shown in FIG. 3, and it is understood that, by carrying out a bias-sputtering, the concavo-convex shape of a groove 31 is kept unchanged even when multiple layers are formed after forming the dummy layers.

As apparent from FIG. 3, the concavo-convex shape varies during the first 300 nm of formation, and the height (depth) of the concavo-convex portion also varies. For this reason, it is desirable that: the depth of the groove in the substrate surface be made deeper than the optimum height of the concavo-convex portion; the region from the starting point of the formation to a point in a range of 200 nm to 500 nm in thickness be made dummy layers 3 to 5 consisting of a transparent layer; and the layers be used for actual multilayer recording layers after the shape thereof is stable. Each of the dummy layers 3 to 5 forms a completely different transparent material layer, for example, an SiO₂ layer, or a deposition layer of SiO₂ and GeO₂, completely different from the layers in a structure consisting of the transparent electrode, the electro-chromic material layer, and the solid electrolyte layer.

If the groove depth in the substrate surface is in the range of 1.1 to 2.0 times the optimum groove depth, tracking in a layer of the portion, in which the concavo-convex height is stable, can be carried out stably. A more preferable range is 1.3 to 1.8 times.

As shown in FIG. 4, which is a cross-sectional view of a condition after bonding a multilayer disk of the present invention, a polycarbonate protection substrate 34 is bonded onto a substrate 38 which is formed as described above. The polycarbonate protection substrate 34 includes a portion above the recording area, and has a bore of about 41 mm, an outer diameter of 120 mm, and a thickness of 0.6 mm. A glass-epoxy substrate 39 is bonded to the inner periphery. The glass-epoxy substrate 39 has a bore (diameter) of 15 mm and an outer diameter of 41 mm, and concentric electrodes 35 and 37 are printed on both sides of the glass-epoxy substrate 39. An electrode 36 passes through from the top side to the bottom side of the glass-epoxy substrate 39 so that the concentric electrodes with the same diameter on the top side and on the bottom side are electrically connected. In the inner periphery of the disk, an end of an electrode extending from a transparent electrode of each layer is taken out inward concentrically or radially, and the concentric electrode 37 is electrically connected with a corresponding transparent electrode 32 by use of an electric conductive adhesive 33. In FIG. 4, only three of the concentric electrodes are depicted, and the rest are omitted. Light is caused to enter from the side of this bonded substrate (from below in FIG. 4). The substrate having this concentric electrode of the inner periphery and the substrate of the outer periphery may be integrated into one plastic substrate.

An address mark is add-on written after fabricating the disk. In contrast with the recording mark of data, which does not have a difference in phase, or which has a small difference in phase, it is preferable that this address mark have a difference in phase as that of the concavo-convex pit in the substrate surface, and that the address mark look like a concavo-convex pit. In this example, therefore, a pulse laser of femto-second used for two-photon absorption recording is used (semiconductor laser of pico-second may be used) to form a phase-difference type mark, in which one of the films changes its nature due to irradiation of a short-time high power density. Thereafter, the phase-difference type mark is read together with a pit originally existing in the substrate surface to thereby describe an address, a clock, and a SYNC signal. Alternatively, the phase-difference type mark alone is made to describe the address, the clock, and the SYNC signal. A numeral reference 12 of FIG. 2 corresponds to the add-on written address mark.

For example, in a case of a Ti-sapphire laser, the wavelength can be varied from 690 nm to 1100 nm, and is equivalent to having absorbed light with a half thereof in the two-photon absorption. Accordingly, in general, the add-on writing of a part of an address mark by means of two-photon absorption recording is the add-on writing in wavelength different from 660 nm and 405 nm, which are used for the user data recording. For example, even if a laser beam of 810 nm, with which the result of two-photon absorption is the same wavelength as that of 405 nm, is used, a condition thereof differs from irradiation of an ordinary purple-blue laser beam of 405 nm. This is because fine air bubbles occur instantaneously in the recording medium and the like, due to irradiation of light with extremely high power for a short time. In a case of a wavelength of 690 nm, which is equivalent to ultraviolet-light irradiation of 345 nm in two-photon absorption, heat can be generated in the transparent portion. As an alternative to using two-photon absorption, when a laser beam of a high power laser (for example, a krypton gas laser) of a wavelength different from that of the laser beam used for the user data recording is used, a significant change can be generated in the recording medium, allowing the address mark to be add-on written thereon.

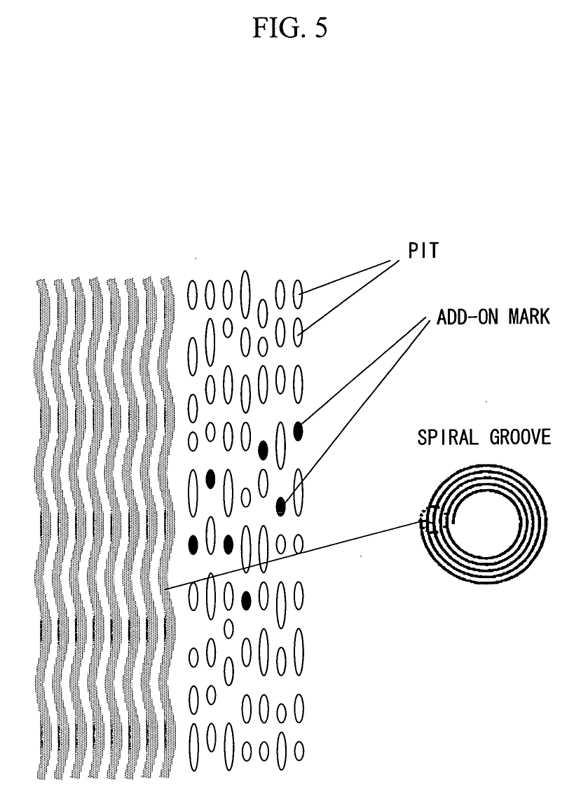

FIG. 5 is a plan view showing a schematic view of an example of the add-on mark. In FIG. 5, a white mark indicates a pit originally existing in the substrate surface, and a black mark indicates an added one. As shown in FIG. 5, it is preferable that the mark be add-on written in places so as to describe the address, the clock, and the SYNC signal when read together with a pit stemming from the pit originally existing in the substrate surface. This is because a pulse laser of femto-second or pico-second has restrictions on the repetition frequency, which is often on the order of kHz. Thus, for example, in a case of the address mark of a header portion in a continuous servo method as in DVD-RAM, it is not practical in that it takes an extremely long time to write all of the address marks. For this reason, the address mark is add-on written in places, only to a portion which differs from other layers.

If a servo using a low power continuous oscillation in a femto-second laser or a pico-second laser is difficult to carry out, a two-beam head is employed, and the address mark is add-on written while carrying out focus-tracking with the femto-second laser or pico-second laser described above, and with an ordinary semiconductor laser or a gas laser, in which a relative position of an optical spot on the disk is fixed. As described above, although a two-beam head is needed for the address formation, the recording and reproducing can be carried out with one beam head in a recording/reproducing apparatus.

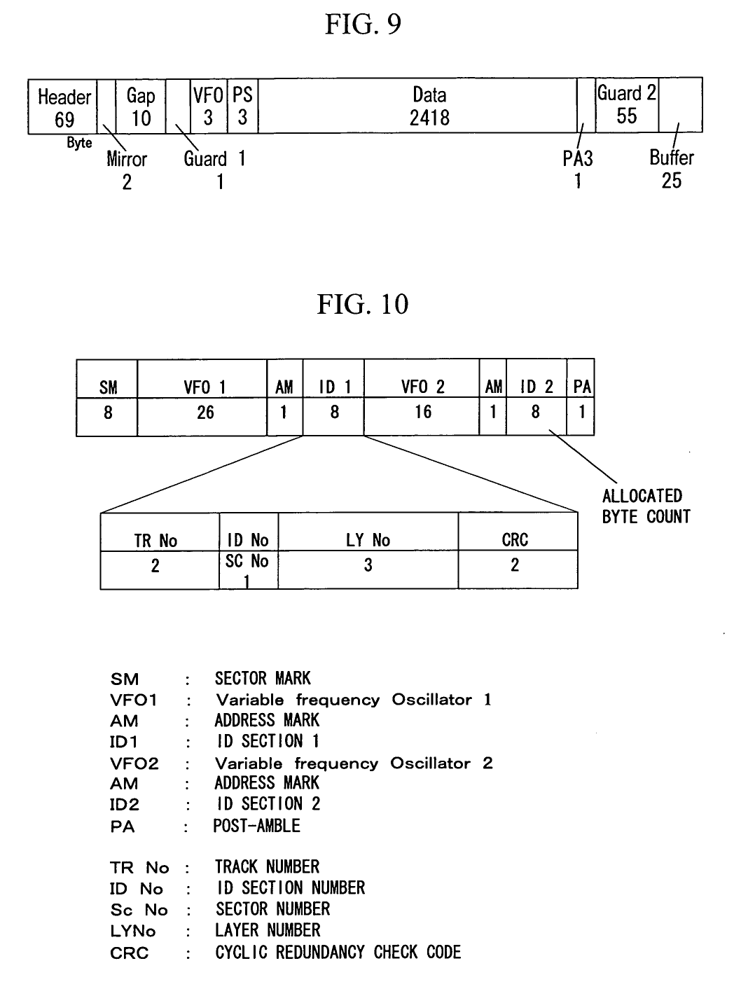

Although the format of the address portion is similar to that of DVD-RAM, 3 bytes are allocated to the address of a layer. The address of a layer is provided in the header portion used for add-on writing in five places at substantially equal intervals in one track (one circle of the disk), so that the above-described add-on writing can be carried out at a high speed. One add-on writing mark can be formed in each of these five places per one revolution of the disk. The format of a sector is shown in FIG. 9, out of which the data arrangement of the header portion is shown in FIG. 10. Depending on reliability of writing and reading, add-on recording may be carried out to places fewer than five places. At the time of positioning of the beam, three or more places are read to confirm the positioning by decision by majority. For the address of a layer, instead of consecutive numbers from one, 24 discontinuous numbers of 3 bytes are allocated, and the address numbers are selected so that the modulation-code-converted numbers (here, following a translation table of 8-16 modulation) may correspond to 24 different numbers by add-on writing three shortest marks. For example, as the arrangement of 16-bit digital data after 8/16 modulation, when four kinds of the following (a) are used for the first byte, three kinds of the following (b) for the second byte, and two kinds of the following (c) for the third byte, these combinations lead to 4×3×2=24 kinds.

| | | | |
|---|---|---|---|
| (a) | 0010010000010000 | 0001001000010000 | 0000100100010000 |
| | 0000010010010000 | | |
| (b) | 0001001001000010 | 0001000100100010 | 0001000010010010 |
| (c) | 0000010000001001 | 0000010000010010 | |

A portion of 1001 is the portion of the add-on written shortest marks. The portion of 1001 exists in each of the first byte, the second byte, and the third byte, and the position of the portion of 1001 varies. In addition, 1 to 1 in a portion connecting from the first byte to the second byte and in a portion connecting from the second byte to the third byte are formed in advance as a long pit in the substrate surface. Specifically, the above-described region of the header portion, which serves as 3 bytes of digital data at the time of 8/16 demodulation, can describe 24 types of layer addresses by using two pits in the substrate surface and three add-on written marks of which the respective positions vary.

A track, to which the address information of a layer is added, may be any one track of the layer at the minimum, it is preferable that add-on writing be performed to two tracks of the inner and outer peripheries of the layer, to three tracks of the inner, intermediate, and outer peripheries, or to tracks more than these tracks. When heating by two-photon absorption at the time of add-on writing, it does not matter whether the relevant layer is or is not colored. In addition to the available method of two-photon absorption recording by means of a femto-second laser or the like, an ordinary semiconductor laser at a relatively strong power may be used for forming an add-on recording mark, which has a difference in phase, in a state where the relevant layer is colored. When it is difficult to form the shortest recording mark of a regular length by means of two-photon absorption recording or the like using a femto-second laser or the like, the recording and reproducing at a specific basic length of the shortest mark length may be carried out, for example, by doubling the shortest mark length of the entire header portion or of the layer address portion alone. In this case, it is preferable that the basic length of a concavo-convex pit of the relevant portion be also changed in advance.

In a case of adding the address information to one track only, even when one mark is add-on written for each 1 byte of the 3 bytes of the layer address described above per one revolution of the disk, the writing of the addresses of one disk is finished in 3×number of ID sections in the header×number of rotations corresponding to the number of layers, in less than one second. However, in a case of confirming the focus position for each layer, time is needed for this confirming. Since the add-on written mark is a phase mark which causes a difference in phase, a cross talk between layers occurs. Thus, as for selection of the header portion in five places, five different places are chosen in the adjacent layers, and in the case where the number of layers is large, the track, to which the layer address is to be add-on written, is further shifted by several tracks in order that errors due to a cross talk do not occur. If the number of ID sections of one header portion is further increased to three or more, reliability is further increased. Because it is known in advance which header portion in which track the address of a target layer has been written, confirmation of the layer address is made possible. In a case where each of header portions, to which layer addresses are add-on written, is made different from one another in all layers, the following method may be employed. More than one mark are add-on written to the header portion, not necessarily by add-on writing to the 3 bytes of 8/16 modulation described above. Accordingly, a mark different from the mark, which is described by the concavo-convex portion originally existing in the substrate, can be detected. Thereby, the address confirmation is carried out.

In this example, a layer to be recorded and reproduced is already selected at the time of selection of a colored layer with a voltage. When only one layer is colored, confirmation of the address of a layer is not necessarily needed. However, because it actually takes close to one second to decolor and color the layer, at least two layers are colored at the time of moving from layer to layer. For this reason, in order to confirm that focus tracking has been carried out properly to a new layer, the address information of a track, to which the above-described layer address is written, needs to be read.

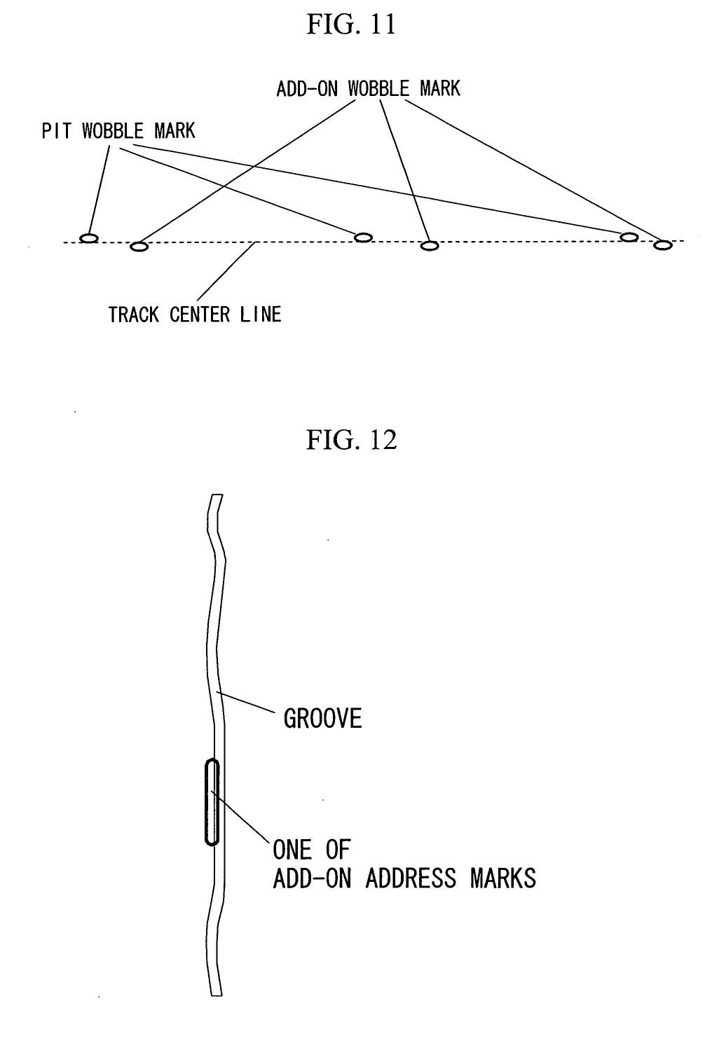

As another example, the address may be described by a relative position of a phase mark, which is add-on written in between two separate pits in the substrate surface, with respect to the pits. Moreover, in a sampled-servo method in which tracking is carried out to the center of a pit pair by detecting the pit pair intermittently arranged on a track, the add-on writing of one of the pair makes it possible to write a mark for describing a tracking guide and an address at a relatively low repetition frequency. As shown in FIG. 11, the address is described by the spacing between pits to serve as the pair and a phase mark to be add-on written. Also in this case, the track to which a layer address is add-on written is set to be one track to several tracks per one layer.

In these cases, a code is determined so that an error correction of the address can be carried out at the time of reading.

Application of a voltage between electrodes, which sandwich a recording layer, causes the recording layer to be colored, and to have the increased absorption rate and reflectivity of a laser beam which is used for recording and reading. It is made possible to cause an arbitrary layer to absorb light and to cause other layers to hardly absorb light. Thereby, because there is no interference from other layers, the film thickness per one layer can be thinned to approximately one hundredth of that of the conventional layer. In addition, a plurality of layers can be arranged within a depth of focus of an aperture lens. Accordingly, layers and capacity can be increased in comparison with a conventional multilayer disk. It goes without saying that layers except for one layer or two layers may be caused not to be within the depth of focus, and that the focal position may be moved to thereby carry out recording and reproducing.

Recording is carried out as follows. The electro-chromic effect of the film is caused to be lost due to the effect of the laser beam and/or of the current. Thereby, the film is caused to have an absorption spectrum, at which the coloring does not occur, or at which the coloring occurs slowly, even when a voltage is applied. Alternatively, the film is caused to have an absorption spectrum which differs from that before recording.

Rewriting possibility can be expected when recording is carried out so that an electro-chromic layer or a solid electrolyte layer phase-shifts between crystal and amorphous or between crystals. Reading is made possible if the coloring or decoloring speed can be made different by an order or more, and if reading is carried out in a state where only a certain region is colored, the certain region being in one of the two phases after applying a voltage. In a case of inorganic material such as WO₃, plus ions in an amorphous state move more readily and the speed thereof is higher.

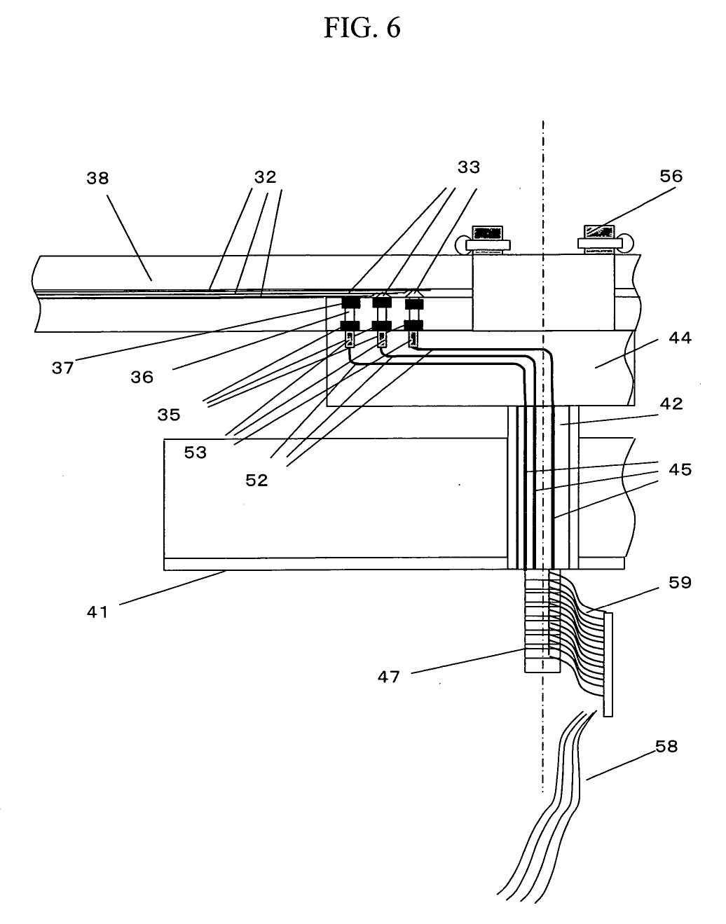

FIG. 6 is a structural view showing an example of a multilayer disk recording/reproducing apparatus used in the present invention. The multilayer disk recording/reproducing apparatus includes: an electric wire 58, which is located below a disk, and which extends from a stationary portion of the recording/reproducing apparatus to a revolving shaft 42 of a motor 41; a lead wire 45, which extends out from slip ring type voltage transfer mechanisms 47 and 59 toward the end of a revolving shaft along the revolving shaft; a disk receptacle (disk mounting portion) 44; a spring built-in pin electrode 53; a lead wire 52 extending inside the disk receptacle toward the spring built-in pin electrode, and the like. The disk is pressed by a spring built-in disk pressure foot 56 so that a concentric circle-shaped electrode 35 of the aforementioned inner periphery of the disk is in contact with the pin electrode 53 of the disk receptacle. The pin electrode does not have to be pin-shaped (narrow pillar or cylinder-shaped). For example, the pin electrode may be a belt-shaped electrode which forms an arc. Current is supplied to the transparent electrode 32 on the substrate 38 via the electrodes 35, 36, and 37. In FIG. 6, only three of the electrode are depicted because the illustration may be obscure if many electrodes near the disk receptacle are depicted. A plurality of electrodes at the side of the apparatus described above each have a narrow and long width, and together form a shape of a long sheet of belt as a whole. When a portion thereof contacting with the rotating electrode is worn out, the contact position can be replaced. The structure of the disk is the same as that of FIG. 4.

In a case where the recording/reproducing light is entered from the side of a bonded substrate, the bonded substrate may be thinned to about 0.1 mm in thickness, and NA of the aperture lens may be increased to 0.85. The track pitch can then be set three-fourths of the conventional case.

As for the electrical connection from the stationary portion, to the rotating portion, of the driving unit, a combination of a light emitting diode or a laser, and a photo detector, a combination of coils, or a combination of a magnet and a coil may be employed, in addition to the contact mechanism such as the slip ring. In the case of the combination of the magnet and the coil, the electrode is selected by varying the distance. However, when a sufficient current cannot be supplied, a plurality of sets of electrodes need to be arranged, resulting in occupying a certain volume inside the driving unit. In the case of using a coil, rectifying is preferable because an alternating voltage occurs.

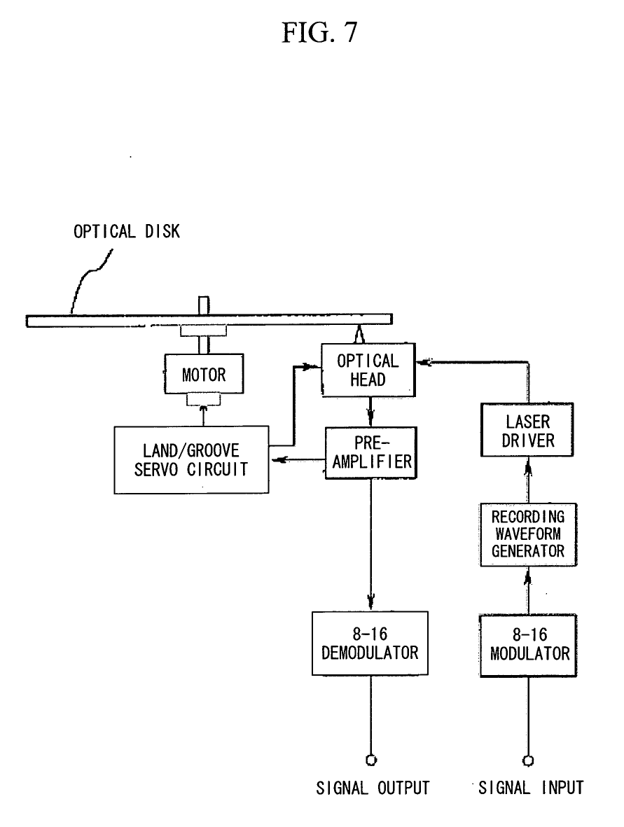

A configuration block diagram of the apparatus is shown in FIG. 7. Hereinafter, the operation of the information recording and reproducing of the present example is described. First, as a method of controlling a motor at the time of recording and reproducing, the method employing a ZCLV (Zoned Constant Linear Velocity) method is described. With the ZCLV method, the number of rotations of a disk is varied for each zone to which recording and reproducing are carried out. As for recording, an original digital signal is 8/16 modulated. Furthermore, one recording mark with a longer mark is converted into a multi-pulse recording wave consisting of more pulses to be recorded. Although not shown in FIG. 7, it is needless to say that, besides the above, there exist a power supply as well as a switching circuit, and a controller for selecting a layer to apply a voltage.

The recording medium of the present invention makes it possible to auto-focus, to confirm tracking, and to confirm addresses in any layer. Thus, multilayer recording and reproducing is made possible by means of an optical head using one laser. Recording is carried out while a target layer alone is sufficiently colored. First, an address is read and confirmed with a laser power used for reproducing. Recording is carried out only in a location, which is irradiated with a high power laser, when a coloring function thereof is lost, or when the coloring thereof is slowed due to heating. At the time of reproducing, a layer to be reproduced is colored in the same manner as the time of recording, the address is confirmed, a laser beam with a reduced power is irradiated, and a reflected light from a mark and from portions other than the mark is detected. Accordingly, a reproduced signal is obtained. The amplitude of the reproduced signal is amplified by a preamplifier circuit, and is converted into 8-bit information for each 16 bits in the case of the 8-16 demodulator. Through the above operations, reproducing of the recorded mark is completed. In this example, the recording and reproducing can be assured by confirming the address of a layer.

### EXAMPLE 2

The present invention is also applied to a multilayer optical disk having a switching layer shown in Technical Digest of International Symposium on Optical Memory (ISOM) 2003 and Fr-J-06 (2003) p. 274. This switching layer is a layer made of material having a nonlinear property in which optical absorption and reflection increase rapidly as the intensity of light to be irradiated increases. In this case, it is preferable that a spacing between layers be made wider than that of the recording medium of Example 1, and that the spacing between layers be set at 0.5 μm or more, so that the power density of a laser beam is high especially in a layer located in the focus position. However, the spacing between layers can be narrower than that of the conventional two-layer optical disk. It is therefore made possible to form a film by continuous sputtering as in the case of the recording medium of Example 1. When the focus position is determined to be a predetermined layer, the optical absorption of this layer increases rapidly due to the switching layer. Accordingly, the recording and reproducing of the user data is made possible. A certain amount of optical absorption is always needed in order to increase optical absorption of the switching layer. Thus, unlike the recording medium of Example 1, attenuation of light due to the optical absorption in layers towards the side of light incidence or a cross talk between layers cannot be eliminated completely. However, the method of Example 2 has more potential for achieving multilayer than the conventional method. The substrate used in Example 1 is used, and the configuration described in the paper is retested as is for the configuration of the recording medium.

As a method of forming a film, the bias-sputtering method as in Example 1 is employed. The method of add-on writing addresses, the configuration of the apparatus, and the method of recording and reproducing are the same as those of Example 1. Because selection of a layer by a voltage or the like is not carried out in this example, high accuracy in reading the layer address is required. It is desirable, therefore, that the layer address be confirmed not only by a plurality of header portions of one track, but also by a plurality of tracks within the same layer.

### EXAMPLE 3

In a case where the address is described by a wobble of a groove as in DVD+RW, as shown in FIG. 12, the add-on writing is carried out as follows. A long add-on phase mark is formed alone or alternately along the groove in a position of a slope which inclines into the groove at one side of the groove or at both sides thereof. This causes the wobble seem present, and thereby the layer address is described. In FIG. 12, grooves adjoining to both sides are omitted. In this example, a wobble corresponding to the address of the layer is not contained in tracks at both sides, and add-on writing is not carried out. A method for coding the layer address may be the same as that of Example 1. However, in a case of describing the layer address by the wobble of the groove, the length of the layer address corresponding to 1 bit is significantly long. Moreover, in a case where the address code is interleaved, add-on writing corresponding thereto is carried out.

The method of manufacturing the recording medium, the configuration of the apparatus, and the method of recording and reproducing are the same as those of Example 1.

### EXAMPLE 4

Example 4 is the same as Example 1 except for the following. A mark to be add-on written is formed, assuming a large difference in phase thereof, in the same position as that of a part of the concavo-convex mark existing in the substrate surface. Accordingly, the phase-difference of the concavo-convex mark is cancelled out, or the difference in phase is 2π in a round trip of light so that the mark seems to be absent. An employed method is that in which a different header portion is formed for each layer, and in which an add-on recording mark is formed in a different track, so that a position mark, which is formed by a concavo-convex portion, for displaying an address is cancelled out by the add-on mark. When submicron fine ink-jet equipment is available, it is also made possible to fill the pit with ink or an organic polymeric material to planarize the pit.

The method of manufacturing the recording medium, the configuration of the apparatus, and the method of recording-reproducing are the same as those of Example 1.

The present invention is especially effective for a recording medium in which a multilayer recording layer can be formed at narrow spacing between layers as in Example 1 and Example 2. However, as in the conventional multilayer recording medium, an effect can be expected even in a multilayer recording medium, in which a cross talk between layers is prevented by widening the spacing between layers in a case where the manufacturing of the recording medium by changing a stamper used for transferring a pit pattern for each layer is disadvantageous to the costs thereof. The cases include a case of a small quantity, large variety production, and the like.

### EXAMPLE 5

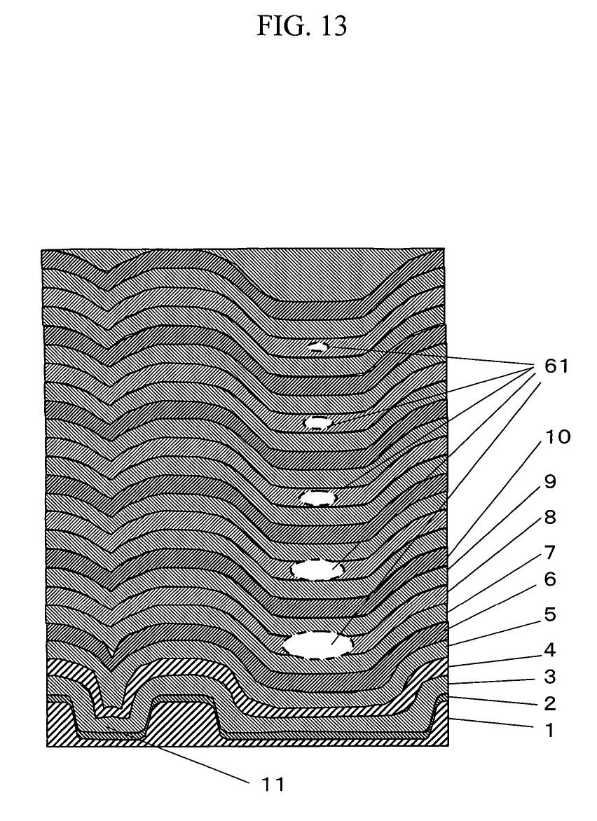

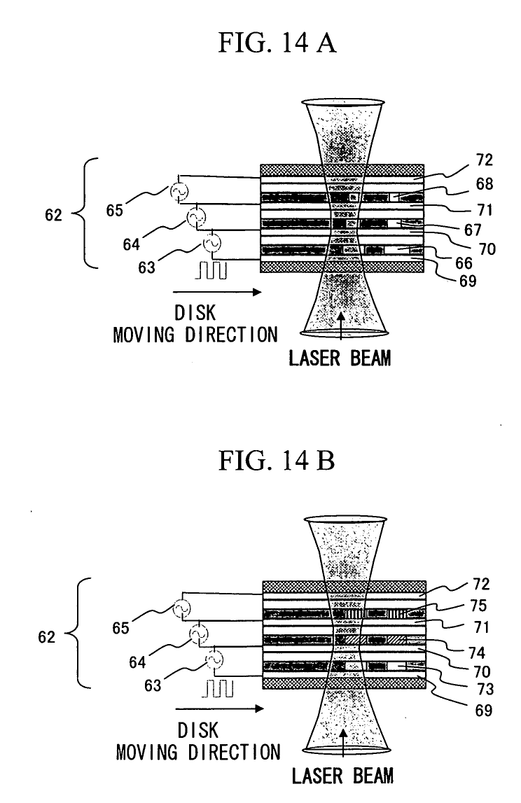

In Example 5, descriptions will be provided for a method for shortening the manufacturing time by recording an add-on mark respectively to a plurality of recording layers at once. FIG. 13 shows a structure, in cross section, of a medium to which a mark is add-on written according to this method. In FIG. 13, a reference numeral 61 denotes an add-on mark of which shape differs for each recording layer. These add-on marks are formed by the method shown in FIGS. 14A and 14B.

FIG. 14A shows a method for recording an add-on mark to a multilayer medium having three recording layers. First, a voltage is applied to each recording layer to set a certain reflectivity with which recording-reproducing can be carried out. To carry out the above, a voltage applying means 62, which is capable of applying voltages respectively to a plurality of layers at once, is used. 3 V is applied to each recording layer using this voltage applying means. In order to apply the voltage to each recording layer simultaneously, potentials at the respective electrode layers are set as follows: a reference potential (0V) is set to be an electrode layer 69; 3V to an electrode layer 70; 6V to an electrode layer 71; and 9V to an electrode layer 72. Specifically, the potential between each electrode is kept at an appropriate application potential (here, 3 V). As the number of recording layers increases, the potential thereof is kept at a potential which is the sum of the reference potential and a voltage.

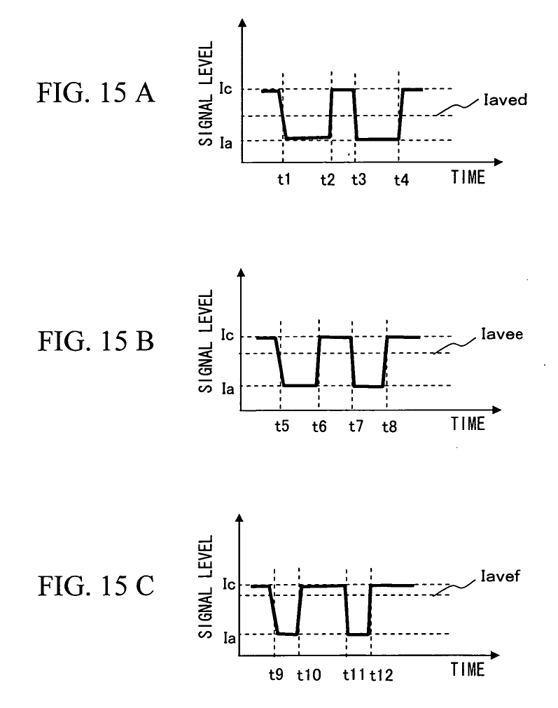

Accordingly, a voltage is applied to each recording layer to thereby set the reflectivity used for recording-reproducing. Specifically, the reflectivity of each recording layer alone is set to be 5%, and the absorptivity thereof to be 15%. Due to the multilayer, the optical properties seen from the side where light enters are as follows. In the first recording layer from the side where light enters, the reflectivity is 5%, and the absorptivity is 15%. In the second recording layer seen from the side where light enters, the reflectivity attenuates to 3.5%, and the absorptivity to 10.5% because the transmissivity of the first recording layer is 70%. In the third recording layer seen from the side where light enters, the reflectivity further attenuates to 2.5%, and the absorptivity to 7.4% because the transmissivity is 49% due to the first and second recording layers. For this reason, even when a laser beam is irradiated at once, the ultimate temperature of the recording layer differs because the absorptivity in each recording layer differs. Specifically, because the size of the region, which reaches a temperature for causing the shape to change, differs in the recording layer, the shape of the mark differs, as shown in FIGS. 15A to 15C. In a case where the shape of the mark differs, the length of the mark of the signal and the length between the marks in the signal at the time of reproduction differ. In FIG. 15A where the degree of the shape change is relatively high, each of the time periods from t1 to t2, and from t3 to t4, in which the signal level of mark portion is Ia, is long, and the time period from t2 to t3, in which the signal level is that of between marks, is short.

As the shape change is slighter, as shown in FIG. 15B, the time periods from t5 to t6 and from t7 to t8, in which the signal level is that of the mark portion, is shorter, and the time period from t6 to t7, in which the signal level is that of between the marks, is longer. As the shape change is still slighter, as shown in FIG. 15C, the time periods from t9 to t10 and from t11 to t12, in which the signal level is that of the mark portion, is further shorter, and the time period from t6 to t7, in which the signal level is that of between the marks, is longer. The average signal levels in each signal, which are Iaved, Iavee, and Iavef, also change and are gradually higher in a similar manner. The address information of a layer can be detected using any one of the aforementioned difference in the signal length of the mark portion, a difference in the signal length in between marks, and a difference in the average signal level. A combination of these improves the accuracy further. Also in a case where the signal level of a mark portion is higher than that in between the marks, a time relationship therein is the same in that, the time period, in which the signal level is that of a mark portion, is shorter when the shape change is slighter. In this example, a case where there are two add-on marks has been illustrated to simplify the descriptions. However, address information of a layer can be detected in the same way even in cases including the following. Such cases include a case where: there is only one add-on mark; there are more than two add-on marks; and there is a combination of an add-on mark with another with a different length.

Moreover, this method can be used also for a type of medium in which a mark is add-on written by causing variations in refractive index, instead of causing variations in shapes. FIG. 14B shows an explanatory drawing. Because an amount of variations of the refractive index differs depending on the input energy, a voltage is applied to each of a plurality of recording layers simultaneously as described above, and a laser irradiation is carried out. Thereby, the absorptivity of the recording layer at the side where light enters is high, and the ultimate temperature of the recording layer is high. On the other hand, the absorptivity of the recording layer distant from the side where light enters is relatively low, and the ultimate temperature of the recording layer is low. For this reason, with respect to the mark in each recording layer, the further away the mark is from the side where light enters, the smaller the variation in refractive index, such as a mark 69 having a largest variation in refractive index, a mark 70 having a next largest variation in refractive index, and a mark 71 having a small variation in refractive index.

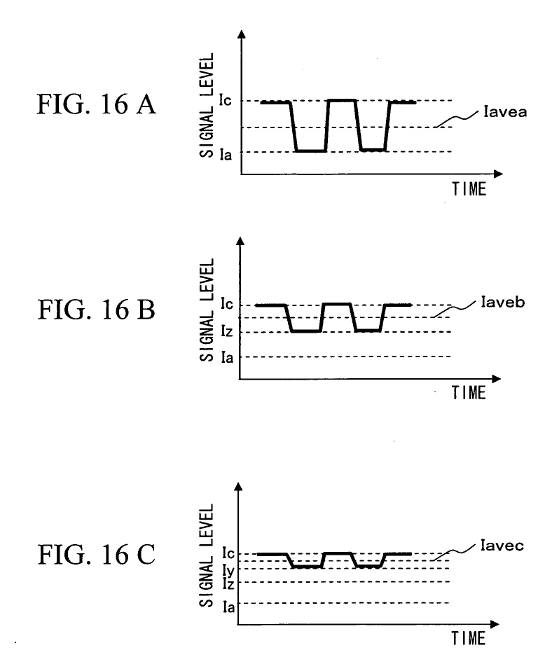

In a case where the refractive index of a mark differs, a signal at the time of reproducing differs in the signal level as shown in FIGS. 16A to 16C. In FIG. 16A where the variation in refractive index is relatively large, the signal level Ia of a mark portion is low, and a difference between the signal level Ic between the marks, and the signal level Ia of the mark portion, is large. As the variation in refractive index is gradually smaller, as shown in FIG. 16B, the signal level Iz of a mark portion is higher than Ia, and a difference between the signal level Ic between the marks, and the signal level Iz of the mark portion, is still smaller. As the variation in refractive index is further smaller, as shown in FIG. 16C, the signal level Iy of the mark portion is higher than Ia, and a difference between the signal level Ic between marks, and the signal level Iy of the mark portion, is further smaller. The average signal levels in each signal, which are Iavea, Iaveb, and Iavec, are also gradually smaller in the similar manner. The address information of a layer can be detected using any one of the difference in the signal level of the mark portion, the difference between the signal level of the mark portion and the signal level between marks, and the difference in the average signal level. A combination of these improves the accuracy further. Even in a case where the signal level of the mark portion is higher than the signal level between the marks, the relationship of the level difference is the same. In a case of an add-on mark where both of the signal level and the difference in the signal level vary, the above methods may be combined.

As described above, as shown in FIGS. 13 and 14, add-on marks each with a shape, which is different from one another, can be recorded by a single laser irradiation, and the manufacturing time can be shortened compared with the method described in Example 1, and the like. Moreover, the address information of a layer can be detected using these add-on marks. Because add-on marks respectively of a plurality of layers are recorded at once in this method, there is also an effect in that the accuracy of a recording position of an add-on mark in a recording layer is high. By taking advantage of this effect, the signal of an add-on mark is detected and compared in order to correct the positional shift, such as eccentricity for each layer, and timings in recording and reproducing.

The method of fabricating the recording medium, the configuration of the apparatus, the method for recording and reproducing, and the like, which are not described in this example, are the same as those of Examples 1 to 4.

### EXAMPLE 6

In Example 6, descriptions will be provided for a method in which the manufacturing time is shortened further by recording an add-on mark respectively to the plurality of recording layers and to a plurality of tracks at once.

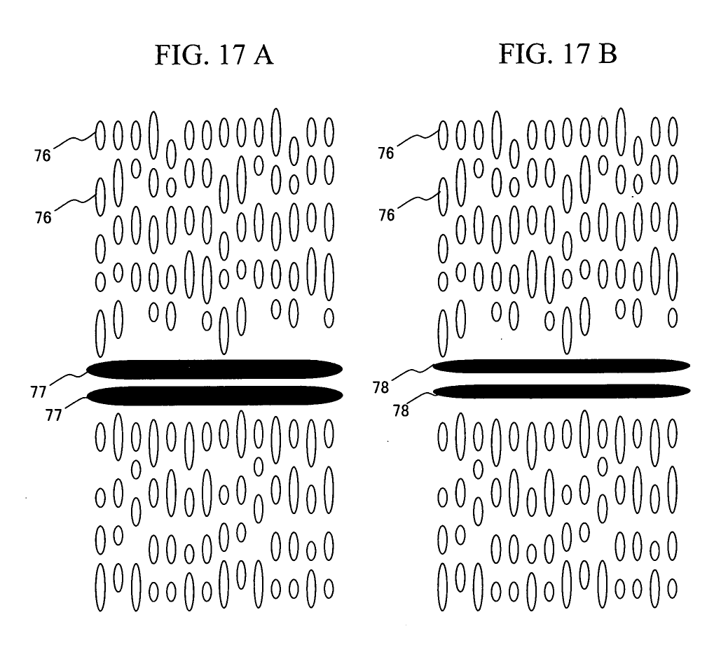

In order to record an add-on mark respectively to the plurality of recording layers and to the plurality of tracks at once, a sheet beam is used as the laser beam, the sheet beam having a long ellipse shape which is long in the direction at an angle to the laser propagating direction (in the track direction) is used as the laser beam. This allows the manufacturing time to be shortened further. FIGS. 17A and 17B show an example of a layout of pits and add-on marks. FIG. 17A is a view showing a situation where pits 76 and add-on marks 77 are formed in a recording layer at the side where light enters. FIG. 17B is a view showing a situation where the pits 76 and add-on marks 78 are formed in a recording layer distant from the side where light enters. Because absorptivity of the recording layer is relatively small, the width of the add-on mark 78 in the propagating direction of the mark to be formed is small. That is, the add-on marks are formed so that the shape of the add-on mark differs for each recording layer. In this example, the add-on marks are formed substantially perpendicular to the laser propagating direction. Meanwhile, also in a case where the add-on marks are formed diagonally, it takes only about several % more for the manufacturing time. In the method using a sheet beam, an add-on mark is recorded respectively to a plurality of layers and to a plurality of tracks at once. This brings about an effect that the accuracy of the recording position of an add-on mark in the recording layers and in tracks is high. By taking advantage of this effect, the signals of add-on marks are detected and compared. Thereby, it is made possible to correct the positional shift of eccentricity for each layer and the like, timings in recording and reproducing, and times among tracks.

The method of fabricating recording medium, the configuration of the apparatus, the method of recording and reproducing, and the like, which are not described in this example, are the same as those of Examples 1 to 5.

What is claimed is:

1. An information recording medium comprising:
a substrate in which any one of a pit pattern and a groove-wobbling pattern is formed; and
a plurality of recording layers formed on the substrate, wherein:
the plurality of recording layers each include an address information which differs for each recording layer; and
the address information is described using at least a part of any one of the pit pattern and the groove-wobbling pattern, the pit pattern being one which is equivalent to the pit pattern formed in the substrate, and which is formed in a position overlapping with the pit pattern formed in the substrate, and the groove-wobbling pattern being one which is equivalent to the grove-wobbling pattern formed in the substrate, and which is formed in a position overlapping with the groove-wobbling pattern formed in the substrate.

2. The information recording medium according to claim 1, wherein the address information is expressed using at least the part of any one of the pit pattern and the groove-wobbling pattern as well as a mark which is add-on written thereto, the pit pattern being one which is equivalent to the pit pattern formed in the substrate, and which is formed in a position overlapping with the pit pattern formed in the substrate, and the groove-wobbling pattern being one which is equivalent to the grove-wobbling pattern formed in the substrate, and which is formed in a position overlapping with the groove-wobbling pattern formed in the substrate.

3. The information recording medium according to claim 2, wherein the mark is a mark expressed by a difference in refractive index.

4. The information recording medium according to claim 1, wherein the part of any one of the pit pattern and the groove-wobbling pattern is erased, the pit pattern being one which is equivalent to the pit pattern formed in the substrate, and which is formed in a position overlapping with the pit pattern formed in the substrate, and the groove-wobbling pattern being one which is equivalent to the grove-wobbling pattern formed in the substrate, and which is formed in a position overlapping with the groove-wobbling pattern formed in the substrate.

5. The information recording medium according to claim 4, wherein any one of the pit pattern or the groove-wobbling pattern is erased by forming any one of an add-on written mark, whose the sum of phase between the reverse phase and the phase difference in pit is 2π in a round trip of light, or by partially filling a concaved portion to planarize corresponding one of the pit pattern or the groove pattern.

6. The information recording medium according to claim 1, wherein the recording mark is formed in a part of the recording layers.

7. The information recording medium according to claim 1, wherein the pit pattern includes pits used for a sampled-servo method.

8. A method of manufacturing an information recording medium, comprising the steps of:
forming a plurality of recording layers so that any one of a pit pattern and a wobble pattern is stored in the recording layers on a substrate in which corresponding one of the pit pattern and the groove-wobbling pattern is formed; and
forming address information different for each recording layer by erasing a part of any one of the pit pattern and the groove-wobbling pattern which each recording layer has, and/or by add-on writing a mark to corresponding one of the pit pattern and the groove-wobbling pattern.

9. The method of manufacturing an information recording medium according to claim 8, wherein the mark is add-on written by causing the recording layer to have two-photon absorption or optical absorption of a wavelength different from that of recording and reproducing to thus change a refractive index thereof.

10. The method of manufacturing an information recording medium according to claim 8, wherein any one of the pit pattern or the groove-wobbling pattern is erased by forming any one of an add-on written mark, whose the sum of a phase between the reverse phase and the phase difference in pit is 2π in a round trip of light.

11. The method of manufacturing an information recording medium according to claim 8, wherein the erasing is carried out by partially filling a concaved portion to planarize the concaved portion.

12. The information recording medium according to claim 2, wherein the mark is a mark expressed by a difference in shape for each of the recording layers.

13. The information recording medium according to claim 2, wherein the mark is a mark expressed by a difference in refractive index for each of the recording layers.

14. The method of manufacturing an information recording medium according to claim 8, wherein the mark is add-on written by irradiating energy on the plurality of recording layers at once and thereby forming a mark in a shape different for each of the recording layers.

15. The method of manufacturing an information recording medium according to claim 8, wherein, while voltages are applied respectively to the plurality of recording layers, the mark is add-on written by irradiating energy on the plurality of recording layers at once and thereby forming a mark in a shape different for each of the recording layers.

16. The method of manufacturing an information recording medium according to claim 8, wherein the mark is add-on written by irradiating energy respectively on the plurality of recording layers at once thereby forming a mark with a refractive index different for each of the recording layers.

17. The method of manufacturing an information recording medium according to claim 8, wherein, while voltages are applied respectively to the plurality of recording layers, the mark is add-on written by irradiating energy on the plurality of recording layers at once and thereby forming a mark with a refractive index different for each of the recording layers.

18. The method of manufacturing an information recording medium according to claim 8, wherein the mark is add-on written by irradiating the plurality of recording layers with a sheet beam of which the long side is arranged in a direction at an angle to a track direction of the information recording medium and thereby forming a mark in a shape different for each of the recording layers.
